(19) United States
(12) Patent Application Publication
(10) Pub. No.: US 2008/0240404 A1
(43) Pub. Date: Oct. 2, 2008

(54) Method and system for aggregating and analyzing data relating to an interaction between a customer and a contact center agent

(76) Inventors: Kelly Conway, Lake Bluff, IL (US); David Gustafson, Lake Forest, IL (US); Douglas Brown, Austin, TX (US); Roger Warford, Hoschton, GA (US); Christopher Danson, Austin, TX (US)

Correspondence Address: MCDERMOTT, WILL & EMERY LLP, 227 WEST MONROE STREET, SUITE 4400, CHICAGO, IL, 60606-5096, US

(21) Appl. No.: 11/731,462

(22) Filed: Mar. 30, 2007

(51) Int. Cl. H04M 3/42

(52) U.S. Cl. 379/265.06; 379/211.01; 379/212.01

(57) ABSTRACT

A method and system for aggregating data associated with an interaction between a customer and a customer service representative is provided. The method is implemented by a readable medium having a plurality of code segments. The method includes the step of receiving customer service representative call activity data, the customer service representative call activity data including one or more of the following data types: customer service representative on-call activity data, customer service representative after-call activity data, customer service representative screen analytics, customer service representative desktop recording data. The method also includes the step of receiving customer call activity data. The method also includes the step of receiving an interaction between a customer and a customer service representative and generating associated voice data from the interaction. The method also includes the step of receiving human resources data from a human resources database, the human resources data being associated with at least one customer service representative. The method also includes the step of analyzing the customer service representative call activity data, the customer call activity data, the voice data, and the human resources data. In addition, a code segment is provided for generating customer service representative performance data based on the analysis of the customer service representative call activity data, the customer call activity data, the voice data and the human resources data.

### CROSS-REFERENCE TO RELATED APPLICATIONS

Not applicable.

### TECHNICAL FIELD

The present invention relates to a method and system for analyzing an interaction between a customer and a customer service representative (“CSR”) at a contact center, and more particularly, for aggregating and analyzing customer service representative data associated with the interaction. This analysis is used to systematically assess CSR performance, assess coaching and training effectiveness, and predict future CSR behavior.

### BACKGROUND OF THE INVENTION

It is known to utilize telephone call centers (“contact centers”) to facilitate the receipt and response of telephone calls or other interactions between a customer and a CSR. Generally, a customer is in contact with a CSR who is responsible for answering the customer's inquiries and directing the customer to the appropriate individual, department, information source, or service as required to satisfy the customer's needs. It is well known to monitor interactions between a customer and a CSR.

Information gathered from the interactions is typically used to monitor the performance of the CSR agents to identify possible training needs or deficiencies in an overall operation of a contact center. Based on a review and analysis of the interaction, a monitor will make suggestions or recommendations to improve the quality of the customer's experience. However, the information gathered has been typically limited to the audio conversation between the customer and the CSR, data entered by the customer through the telephone key pad, and the screens viewed by the CSR. As such, the monitor is restricted in thoroughly evaluating the performance of the CSR and in completely understanding the experience of the customer during the interaction. Furthermore, this data has historically been in an unstructured format that only allows for manual, human analysis versus a systematic, computer based analysis of agent performance.

In many instances, it may also be desirable to analyze the entirety of the aggregate data gleaned from an interaction, and measure that aggregate data against the characteristics of the CSR. For example, it would be useful in a final analysis to automatically consider CSR human resources data and its impact on the customer experience in correlation with the aggregated data.

Thus, there is a need in customer relationship management (“CRM”) for tools useful in fully evaluating a CSR's performance, as it relates to an interaction or group of interactions, in view of the human resource characteristics of the CSR or group of CSRs. In particular, a need exists for tools that will allow for evaluating the impact of both the interactions and the human resource characteristics of CSRs on the operations of a contact center.

The present invention is provided to solve the problems discussed above and other problems, and to provide advantages and aspects not previously provided. A full discussion of the features and advantages of the present invention is deferred to the following detailed description, which proceeds with reference to the accompanying drawings.

### SUMMARY OF THE INVENTION

According to the present invention, a computer program for aggregating data associated with at least one interaction between a customer and a customer service representative is provided. The computer program is embodied on a computer readable storage medium adapted to control a computer. The computer program comprises a plurality of code segments for performing the task. In particular, CSR call activity data associated with the interaction is received. The CSR call activity data includes at least one of the following data types: CSR on-call activity data, CSR after-call activity data, CSR screen analytics, and CSR desktop recording data.

Customer call activity data is received. Human resources data associated with the customer service representative is also received. Voice data associated with the interaction is also received. Additionally, the customer service representative call activity data, the customer call activity data, the voice data, and the human resources data is analyzed and CSR performance data is generated based on the analysis of the aggregate data.

According to another aspect of the invention, another embodiment of a computer readable medium for aggregating data associated with at least one interaction between a customer and a customer service representative is provided. Again, the computer program is embodied on a computer readable storage medium adapted to control a computer. The computer program comprises a plurality of code segments for performing the task. In particular, customer service representative call activity data associated with the interaction, the CSR call activity data comprising at least one of CSR on-call activity data, customer service representative after-call activity data, CSR screen analytics and CSR desktop recording data. Additionally, customer call activity data is received. Human resources data associated with the customer service representative is also received.

Voice data associated with the interaction is received. The code segment for receiving voice data includes instructions (e.g., a code segment) for separating the voice data into customer voice data and customer service representative voice data. The separated customer service representative voice data and the separated customer voice data are mined and analyzed by applying a linguistic-based psychological behavioral model thereto. From the analysis, behavioral assessment data corresponding to the separated customer service representative voice data and the separated customer voice data is generated.

The aggregated voice data, behavioral assessment data, customer service representative call activity data, customer call activity data, and the human resources data are analyzed and customer service representative performance data, based on the analysis of the aggregated data, is generated.

According to another aspect of the invention, the separated customer service representative voice data and the separated customer voice data are analyzed by applying a distress based model to the separated customer service representative voice data and the separated customer voice data. Distress assessment data corresponding to the separated customer service representative voice data and the separated customer voice data is then generated. The voice data can also be analyzed by applying a non-linguistic event analysis thereto. Based on the analysis, phone event assessment data is generated.

According to still another aspect of the invention, the code segment provided for separating voice data into customer voice data and customer service representative voice data includes instructions, in the form of a code segment, for identifying a communication protocol associated with the voice data. A code segment records the voice data to a first electronic data file comprised of a first and second audio track. The customer service representative voice data is automatically recorded on the first audio track based on the identified communication protocol, and the customer voice data is automatically recorded on the second audio track based on the identified communication protocol.

According to another aspect of the invention, the customer service representative performance data includes a customer service representative call performance score.

According to another aspect of the invention, the customer service representative performance data can include one or more of either: call event assessment data, voice assessment data, and after-call activity assessment data, as any of these are measured relative to the total interaction time between the customer service representative and a customer.

According to yet another aspect of the invention, aggregate performance data is generated from at least two of a plurality of customer service representative interactions. The aggregate performance data has a total aggregate time associated therewith and includes a plurality of aggregated data sub-categories. The aggregated data sub-categories each has a constituent time component associated therewith. Additionally, a constituent time component of at least one of the data sub-categories is analyzed relative to the total aggregate time for a CSR interaction or interactions.

According to another aspect of the invention, the generated customer service representative performance data is compared with one or more of the following: a previously generated customer service representative performance data, past coaching event data, predetermined threshold data, and peer customer service representative performance data.

According to still another aspect of the invention, a graphical user interface adapted to display the generated customer service representative performance data is generated.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a block diagram of a contact center in accordance with the present invention;

FIG. 2 is a block diagram of the architecture for a telephonic communication system according to the present invention;

FIG. 3 is a block diagram of a computer used in connection with the present invention;

FIG. 4 is a block diagram of a telephonic communication system with a multi-port PSTN module according to the present invention;

FIG. 5 is a block diagram illustrating the process of recording and separating voice data in accordance with the present invention;

FIG. 6 is a flow chart illustrating the process of separating a telephonic communication in accordance with the present invention;

FIG. 7 is a flow chart illustrating the process of analyzing separated constituent voice data of a telephonic communication in accordance with the present invention;

FIG. 8 is a flow chart illustrating the process of analyzing separated constituent voice data of a telephonic communication in accordance with the present invention;

FIG. 9 is a flow chart illustrating a system for aggregating data according to the present invention;

FIG. 10 is a flow chart illustrating a system for aggregating data according to the present invention;

FIG. 11 is a graphical representation of aggregate CSR performance data in accordance with the present invention;

FIG. 12 are graphical representations illustrating the aggregation of CSR performance data by location in accordance with the present invention;

FIG. 13 is a graphical representation aggregate illustrating the aggregation of CSR performance data by customer segment in accordance with the present invention;

FIG. 14 is a graphical representation of aggregate CSR performance data in accordance with the present invention;

FIG. 15 is a graphical representation of the average of a CSR call performance scores by week in accordance with the present invention;

FIG. 16 is a graph illustrating the impact of coaching events on a group of CSRs' call performance scores in accordance with the present invention;

FIG. 17 is a table comparing CSR performance data with peer CSR performance data in accordance with the present invention;

FIG. 18 is a plurality of graphs illustrating CSR call performance score distribution by location in accordance with the present invention; and

FIG. 19 is a table illustrating by CSR quartile the cost impact of CSR performance data on the contact center.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

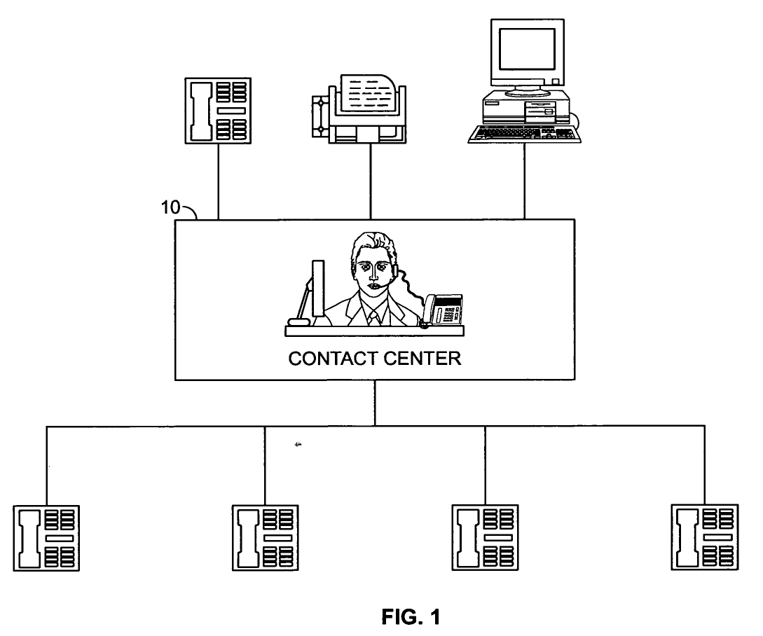

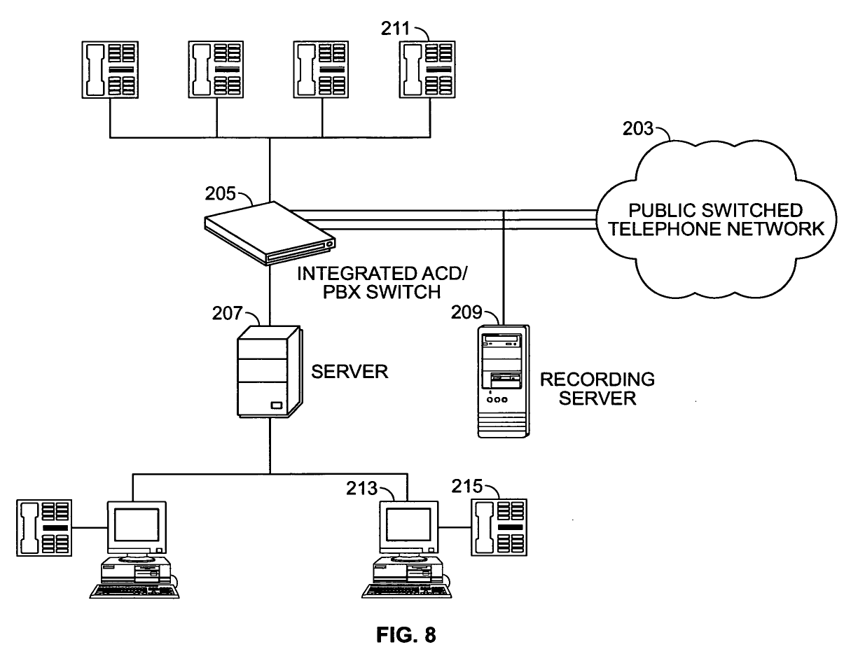

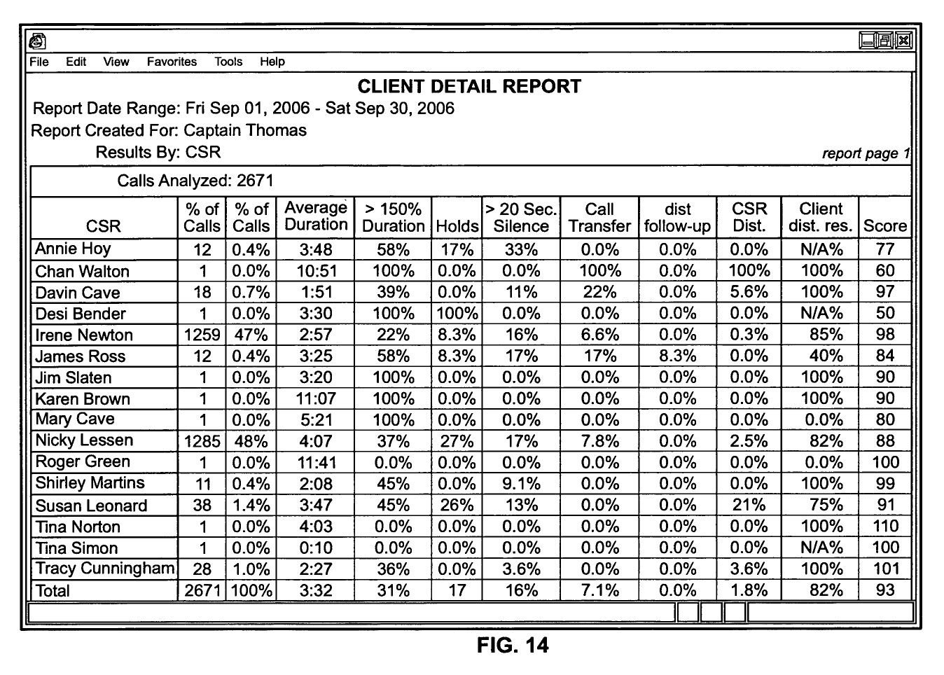

Referring to FIGS. 1-19, a method and system for analyzing an interaction between a customer and a CSR at a contact center is provided. A “contact center” as used herein can include any facility or system server suitable for receiving and recording electronic interactions from customers. Such interactions can include, for example, telephone calls, facsimile transmissions, e-mails, web interactions, voice-over IP (“VoIP”) and video. It is contemplated that these interactions may be transmitted by and through any type of telecommunication device and over any medium suitable for carrying data. For example, the interactions may be transmitted by or through telephone lines, cable or wireless communications. As shown in FIG. 1, the contact center 10 of the present facilitates interactions that occur between a customer and a contact center during fulfillment of a customer transaction.

According to one embodiment of the invention, the system used in connection with the present method includes an interactive voice response (IVR) system, a telephone switch or switching system, a routing server and a recording server. Now will be described in more specific terms, the computer hardware associated with operating the computer program that may be used in connection with the present invention.

Process descriptions or blocks in figures should be understood as representing modules, segments, or portions of code which include one or more executable instruction for implementing specific logical functions or steps in the process. Alternate implementations are included within the scope of the embodiments of the present invention in which functions may be executed out of order from that shown or discussed, including substantially concurrently or in reverse order, depending on the functionality involved, as would be understood by those having ordinary skill in the art.

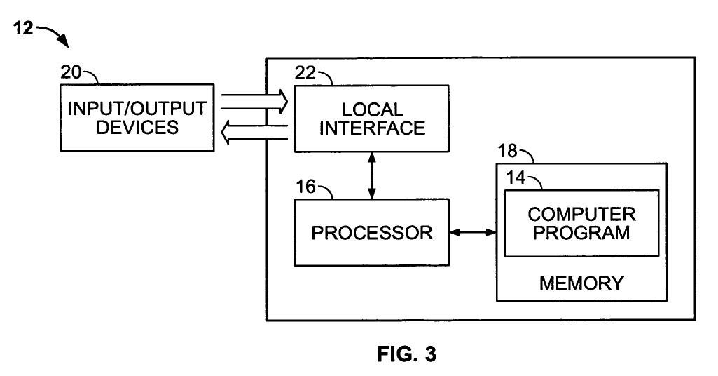

FIG. 3 is a block diagram of a computer or server 12. For purposes of understanding the hardware as described herein, the terms “computer” and “server” have identical meanings and are interchangeably used. Computer 12 includes control system 14. The control system 14 of the invention can be implemented in software (e.g., firmware), hardware, or a combination thereof. In a currently contemplated preferred embodiment, the control system 14 is implemented as an executable program in software, and is executed by one or more special or general purpose digital computer(s), such as a personal computer (PC; IBM-compatible, Apple-compatible, or otherwise), personal digital assistant, workstation, minicomputer, or mainframe computer. An example of a general purpose computer that can implement the control system 14 of the present invention is shown in FIG. 3. The control system 14 may reside in, or have portions residing in, any computer such as, but not limited to, a general purpose personal computer. Therefore, computer 12 of FIG. 3 may be representative of any computer in which the control system 14 resides or partially resides.

Generally, in terms of hardware architecture, as shown in FIG. 3, the computer 12 includes a processor 16, memory 18, and one or more input and/or output (I/O) devices 20 (or peripherals) that are communicatively coupled via a local interface 22. The local interface 22 can be, for example, but is not limited to, one or more buses or other wired or wireless connections, as is known in the art. The local interface 22 may have additional elements, which are omitted for simplicity, such as controllers, buffers (caches), drivers, repeaters, and receivers, to enable communications. Further, the local interface may include address, control, and/or data connections to enable appropriate communications among the other computer components.

The processor 16 is a hardware device for executing software, particularly software stored in memory 18. The processor 16 can be any custom made or commercially available processor, a central processing unit (CPU), an auxiliary processor among several processors associated with the computer 12, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x8 or Pentium series microprocessor from Intel Corporation, a PowerPC microprocessor from IBM, a Sparc microprocessor from Sun Microsystems, Inc., a 8xxx series microprocessor from Motorola Corporation, an Intel Xeon (Single and Dual Core), or an Intel Xeon Processor MP (Single and Dual Core).

The memory 18 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 18 may incorporate electronic, magnetic, optical, and/or other types of storage media. The memory 18 can have a distributed architecture where various components are situated remote from one another, but can be accessed by the processor 16. The software in memory 18 may include one or more separate programs, each of which comprises an ordered listing of executable instructions for implementing logical functions. In the example of FIG. 3, the software in the memory 18 includes the control system 14 in accordance with the present invention and a suitable operating system (O/S) 24. A non-exhaustive list of examples of suitable commercially available operating systems 24 is as follows: (a) a Windows operating system available from Microsoft Corporation, including but not limited to, Microsoft Vista and Windows Mobile Client; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system 24 essentially controls the execution of other computer programs, such as the control system 14, and provides scheduling, input-output control, file and data management, memory management, and communication control and related services.

The control system 14 may be a source program, executable program (object code), script, or any other entity comprising a set of instructions to be performed. When a source program, the program needs to be translated via a compiler, assembler, interpreter, or the like, which may or may not be included within the memory 18, so as to operate properly in connection with the O/S 24. Furthermore, the control system 14 can be written as (a) an object oriented programming language, which has classes of data and methods, or (b) a procedure programming language, which has routines, subroutines, and/or functions, for example but not limited to, C, C++, C# (C Sharp), Pascal, Basic, Fortran, Cobol, Perl, Java, Ada, and PHP. In one embodiment, the control system 14 is written in C++. The I/O devices 20 may include input devices, for example but not limited to, a keyboard, mouse, scanner, microphone, touch screens, interfaces for various medical devices, bar code readers, stylus, laser readers, radio-frequency device readers, etc. Furthermore, the I/O devices 20 may also include output devices, for example but not limited to, a printer, bar code printers, displays, etc. Finally, the I/O devices 20 may further include devices that communicate both inputs and outputs, for instance but not limited to, a modulator/demodulator (a modem for accessing another device, system, or network), a radio frequency (RF) or other transceiver, a telephonic interface, a bridge, a router, etc.

If the computer 12 is a PC, workstation, PDA, or the like, the software in the memory 18 may further include a basic input output system (BIOS) (not shown in FIG. 3). The BIOS is a set of software routines that initialize and test hardware at startup, start the O/S 24, and support the transfer of data among the hardware devices. The BIOS is stored in ROM so that the BIOS can be executed when the computer 12 is activated. When the computer 12 is in operation, the processor 16 is configured to execute software stored within the memory 18, to communicate data to and from the memory 18, and to generally control operations of the computer 12 pursuant to the software. The control system 14 and the O/S 24, in whole or in part, but typically the latter, are read by the processor 16, perhaps buffered within the processor 16, and then executed.

When the control system 14 is implemented in software, as is shown in FIG. 3, it should be noted that the control system 14 can be stored on any computer readable medium for use by or in connection with any computer related system or method. In the context of this document, a “computer-readable medium” can be any medium that can store, communicate, propagate, or transport the program for use by or in connection with the instruction execution system, apparatus, or device. The computer readable medium can be for example, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). The control system 14 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In another embodiment, where the control system 14 is implemented in hardware, the control system 14 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

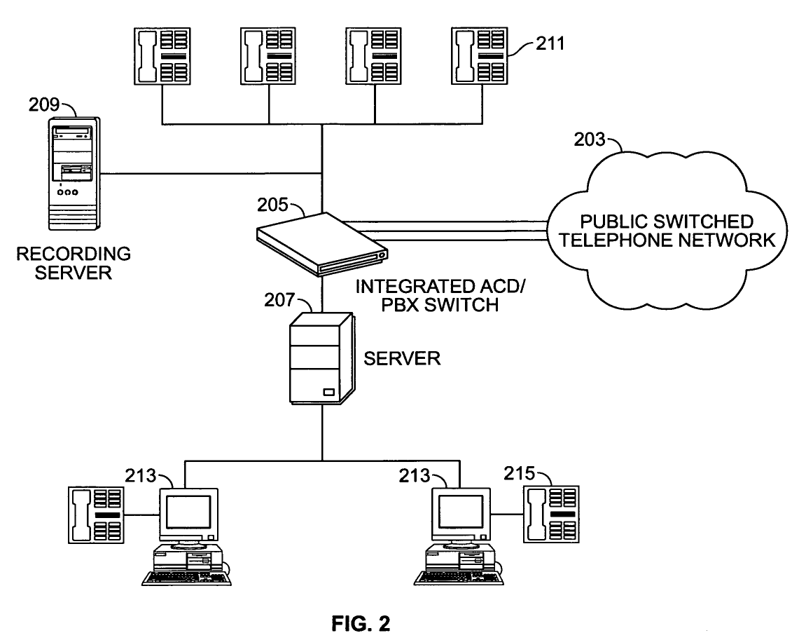

As may be seen in FIG. 2, a customer sending a telephonic signal may access a contact center 10 through the public switched telephone network (PSTN) 203. An automatic call distribution system (PBX/ACD) 205 directs the communication to one of a plurality of CSR work stations 213. Each CSR work station 213 includes, for example, a computer 213 and a telephone 215. Alternatively, the telephonic signal can be distributed through a private branch exchange (PBX), having a public switched telephone network (PSTN) 203 connected to the PBX through a PBX switch 205. The PBX switch 205 provides an interface between the PSTN 203 and a local network. Preferably, the interface is controlled by software stored on a telephony server 207 coupled to the PBX switch 205. The PBX switch 205, using interface software, connects trunk and line station interfaces of the public switch telephone network 203 to stations of a local network or other peripheral devices contemplated by one skilled in the art. Further, in another embodiment, the PBX switch may be integrated with telephony server 207. The stations may include various types of communication devices connected to the network, including the telephony server 207, a recording server 209, telephone stations 211, and client personal computers 213 equipped with telephone stations 214. The local network may further include fax machines and modems and other devices.

According to the present invention, CTI is provided. In a preferred embodiment discussed herein, CTI resides on a telephony server 207. However, it will be understood by those skilled in the art that CTI can reside on its own server or at other hardware described herein. Generally, in terms of hardware architecture, the telephony server 207 includes a processor, memory, and one or more input and/or output (I/O) devices (or peripherals) that are communicatively coupled via a local interface. The processor can be any custom-made or commercially available processor, a central processing unit (CPU), an auxiliary processor among several processors associated with the telephony server 207, a semiconductor based microprocessor (in the form of a microchip or chip set), a macroprocessor, or generally any device for executing software instructions. The memory of the telephony server 207 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). The telephony server 207 may further include a keyboard and a mouse for control purposes, and an attached graphic monitor for observation of software operation. It will be understood that the telephony server may include standard CTI technology, such as that sold by Cisco, Avaya, Genesys or other provider of CTI technology.

According to one embodiment, the telephony server 207 also incorporates PBX control software to control the initiation and termination of connections between stations and via outside trunk connections to the PSTN 203. In addition, the software may monitor the status of all telephone stations 211 in real-time on the network and may be capable of responding to telephony events to provide traditional telephone service. This may include the control and generation of the conventional signaling tones such as dial tones, busy tones, ring back tones, as well as the connection and termination of media streams between telephones on the local network. Further, the PBX control software may use a multi-port module 223 and PCs to implement standard PBX functions such as the initiation and termination of telephone calls, either across the network or to outside trunk lines, the ability to put calls on hold, to transfer, park and pick up calls, to conference multiple callers, and to provide caller ID information. Telephony applications such as voice mail and auto attendant may be implemented by application software using the PBX as a network telephony services provider.

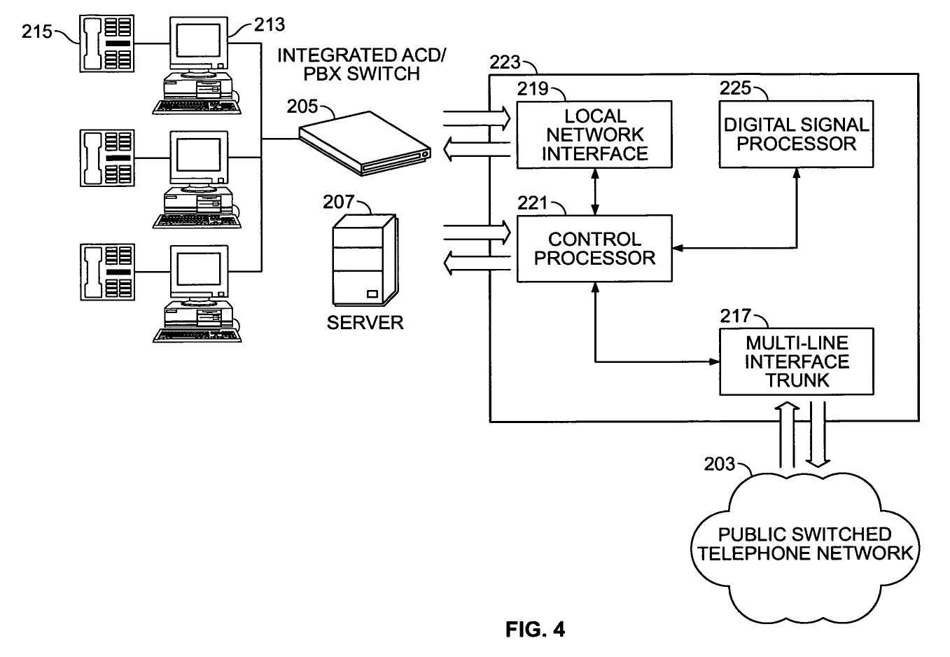

Referring to FIG. 4, in one embodiment, the telephony server 207 is equipped with multi-port PSTN module 223 having circuitry and software to implement a trunk interface 217 and a local network interface 219. The PSTN module 223 comprises a control processor 221 to manage the transmission and reception of network messages between the PBX switch 205 and the telephony server 207. The control processor 221 is also capable of directing network messages between the PBX switch 205, the local network interface 219, the telephony network server 207, and the trunk interface 217. In the one embodiment, the local network uses Transmission Control Protocol/Internet Protocol (TCP/IP), also known as Voice Over IP (VoIP). The network messages may contain computer data, telephony transmission supervision, signaling and various media streams, such as audio data and video data. The control processor 221 directs network messages containing computer data from the PBX switch 205 to the telephony network server 207 directly through the multi-port PSTN module 223.

The control processor 221 may include buffer storage and control logic to convert media streams from one format to another, if necessary, between the trunk interface 217 and the local network. The trunk interface 217 provides interconnection with the trunk circuits of the PSTN 203. The local network interface 219 provides conventional software and circuitry to enable the telephony server 207 to access the local network. The buffer RAM and control logic implement efficient transfer of media streams between the trunk interface 217, the telephony server 207, the digital signal processor 225, and the local network interface 219.

The trunk interface 217 utilizes conventional telephony trunk transmission supervision and signaling protocols required to interface with the outside trunk circuits from the PSTN 203. The trunk lines carry various types of telephony signals such as transmission supervision and signaling, audio, fax, or modem data to provide plain old telephone service (POTS). In addition, the trunk lines may carry other communication formats such T1, ISDN or fiber service to provide telephony or multimedia data images, video, text or audio.

The control processor 221 manages real-time telephony event handling pertaining to the telephone trunk line interfaces, including managing the efficient use of digital signal processor resources for the detection of caller ID, DTMF, call progress and other conventional forms of signaling found on trunk lines. The control processor 221 also manages the generation of telephony tones for dialing and other purposes, and controls the connection state, impedance matching, and echo cancellation of individual trunk line interfaces on the multi-port PSTN module 223.

Preferably, conventional PBX signaling is utilized between trunk and station, or station and station, such that data is translated into network messages that convey information relating to real-time telephony events on the network, or instructions to the network adapters of the stations to generate the appropriate signals and behavior to support normal voice communication, or instructions to connect voice media streams using standard connections and signaling protocols. Network messages are sent from the control processor 221 to the telephony server 207 to notify the PBX software in the telephony server 207 of real-time telephony events on the attached trunk lines. Network messages are received from the PBX Switch 205 to implement telephone call supervision and may control the set-up and elimination of media streams for voice transmission.

The local network interface 219 includes conventional circuitry to interface with the local network. The specific circuitry is dependent on the signal protocol utilized in the local network. In one embodiment, the local network may be a local area network (LAN) utilizing IP telephony or VoIP. IP telephony integrates audio and video stream control with legacy telephony functions and may be supported through the H.323 protocol. H.323 is an International Telecommunication Union-Telecommunications protocol used to provide voice and video services over data networks. H.323 permits users to make point-to-point audio and video phone calls over a local area network. IP telephony systems can be integrated with the public telephone system through a local network interface 219, such as an IP/PBX-PSTN gateway, thereby allowing a user to place telephone calls from an enabled computer. For example, a call from an IP telephony client to a conventional telephone would be routed on the LAN to the IP/PBX-PSTN gateway. The IP/PBX-PSTN gateway translates H.323 protocol to conventional telephone protocol and routes the call over the conventional telephone network to its destination. Conversely, an incoming call from the PSTN 203 is routed to the IP/PBX-PSTN gateway and translates the conventional telephone protocol to H.323 protocol.

As noted above, PBX trunk control messages are transmitted from the telephony server 207 to the control processor 221 of the multi-port PSTN. In contrast, network messages containing media streams of digital representations of real-time voice are transmitted between the trunk interface 217 and local network interface 219 using the digital signal processor 225. The digital signal processor 225 may include buffer storage and control logic. Preferably, the buffer storage and control logic implement a first-in-first-out (FIFO) data buffering scheme for transmitting digital representations of voice audio between the local network to the trunk interface 217. It is noted that the digital signal processor 225 may be integrated with the control processor 221 on a single microprocessor.

The digital signal processor 225 can include a coder/decoder (CODEC) connected to the control processor 221. The CODEC may be a type TCM29c 13 integrated circuit made by Texas Instruments, Inc. In one embodiment, the digital signal processor 225 receives an analog or digital voice signal from a station within the network or from the trunk lines of the PSTN 203. The CODEC converts the analog voice signal into a digital form, such as digital data packets. It should be noted that the CODEC is not used when connection is made to digital lines and devices. From the CODEC, the digital data is transmitted to the digital signal processor 225 where telephone functions take place. The digital data is then passed to the control processor 221 which accumulates the data bytes from the digital signal processor 225. It is preferred that the data bytes are stored in a first-in-first-out (FIFO) memory buffer until there is sufficient data for one data packet to be sent according to the particular network protocol of the local network. The specific number of bytes transmitted per data packet depends on network latency requirements as selected by one of ordinary skill in the art. Once a data packet is created, the data packet is sent to the appropriate destination on the local network through the local network interface 219. Among other information, the data packet contains a source address, a destination address, and audio data. The source address identifies the location the audio data originated from and the destination address identifies the location the audio data is to be sent.

The system permits bi-directional communication by implementing a return path allowing data from the local network, through the local network interface 219, to be sent to the PSTN 203 through the multi-line PSTN trunk interface 217. Data streams from the local network are received by the local network interface 219 and translated from the protocol utilized on the local network to the protocol utilized on the PSTN 203. The conversion of data may be performed as the inverse operation of the conversion described above relating to the IP/PBX-PSTN gateway. The data stream is restored in appropriate form suitable for transmission through to either a connected telephone 211, 215 or an interface trunk 217 of the PSTN module 223, or a digital interface such as a T1 line or ISDN. In addition, digital data may be converted to analog data for transmission over the PSTN 203.

Generally, the PBX switch of the present invention may be implemented with hardware or virtually. A hardware PBX has equipment located local to the user of the PBX system. The PBX switch 205 utilized may be a standard PBX manufactured by Avaya, Siemens AG, NEC, Nortel, Toshiba, Fujitsu, Vodavi, Mitel, Ericsson, Panasonic, InterTel or Cisco. In contrast, a virtual PBX has equipment located at a central telephone service provider and delivers the PBX as a service over the PSTN 203.

As illustrated in FIG. 2, the system includes a recording server 209 for recording network messages transmitted within the system. As shown in FIG. 2, the recording server 209 may be connected to a port on the local network or to the PSTN trunk line. The recording server 209 is also communicably coupled to the telephony server 207. The recording server 209 includes a control system software, namely, recording software. The recording software of the invention can be implemented in software (e.g., firmware), hardware, or a combination thereof. In a currently contemplated preferred embodiment, the recording software is implemented in software, as an executable program, and is executed by one or more special or general purpose digital computer(s). The recording software may reside in, or have portions residing in, any computer such as, but not limited to, a general purpose personal computer.

Generally, hardware architecture is the same as that discussed above and shown in FIG. 3. Specifically, the recording server 209 includes a processor, memory, and one or more input and/or output (I/O) devices (or peripherals) that are communicatively coupled via a local interface as previously described. The local interface can be, for example, but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the other computer components.

The recording server 209 incorporates recording software for recording, in addition to other inputs associated with an interaction, a telephone signal based on the source address and/or destination address of the signal. The method utilized by the recording server 209 depends on the communication protocol utilized on the communication lines to which the recording server 209 is coupled. In the communication system contemplated by the present invention, the signal carrying audio data of a communication between at least two users may be an analog signal or a digital signal in the form of a network message. In one embodiment, the signal is an audio data transmitted according to a signaling protocol, for example the H.323 protocol described above.

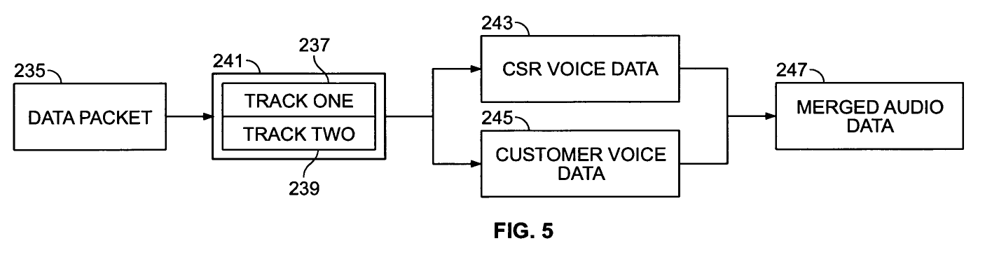

One example of a recording method that may be used in the present system 200 is illustrated in FIG. 5 and described herein. In the embodiment of FIG. 5, when an outside customer reaches the system through the multi-line interface trunk 217, their voice signal is digitized (if needed), and converted into digital data packets 235 according to the communication protocol utilized on the local network of the system. The data packet 235 comprises a source address identifying the address of the outside customer, a destination address identifying the address of the contact center CSR, and first constituent audio data comprising at least a portion of the outside customer's voice. The data packet 235 can further comprise routing data identifying how the data packet 235 should be routed through the system and other relevant data. Once the data packet 235 is created, the data packet 235 is sent to the appropriate destination on the local network, such as to a contact center CSR, through the local network interface 219. The PBX and/or an automatic call distributor (ACD) can determine the initial communication setup, such as the connection state, impedance matching, and echo cancellation, according to predetermined criteria.

Similar to the process described above, when the contact center CSR speaks, their voice is digitized (if needed) and converted into digital data packet 235 according to the communication protocol utilized on the local network. The data packet 235 comprises a source address identifying the address of the contact center CSR, a destination address identifying the address of the outside customer, and second constituent audio data comprising at least a portion of the contact center CSR's voice. The data packet 235 is received by the local network interface 219 and translated from the communication protocol utilized on the local network to the communication protocol utilized on the PSTN 203. The conversion of data can be performed as described above. The data packet 235 is restored in appropriate form suitable for transmission through to either a connected telephone 211, 215 or an interface trunk 217 of the PSTN module 223, or a digital interface such as a T1 line or ISDN. In addition, digital data can be converted to analog data for transmission through the PSTN 203.

The recording server 209 receives either a data packet 235 comprising: the source address identifying the address of the outside customer, a destination address identifying the address of the contact center CSR, and the first constituent audio data comprising at least a portion of the outside customer's voice; or a data packet 235 comprising a source address identifying the address of the contact center CSR, a destination address identifying the address of the outside customer, and second constituent audio data comprising at least a portion of the CSR's voice. It is understood by one of ordinary skill in the art that the recording server 209 is programmed to identify the communication protocol utilized by the local network and extract the audio data within the data packet 235. In one embodiment, the recording server 209 can automatically identify the utilized communication protocol from a plurality of communication protocols. The plurality of communication protocols can be stored in local memory or accessed from a remote database.

Referring now to FIG. 5, The recording server 209 comprises recording software to record the interaction between the customer and the CSR in a single data file in a stereo format. The first data file 241 has at least a first audio track 237 and a second audio track 239. Once a telephone connection is established between a customer and a CSR, the recording software creates a first data file 241 to record the interaction between the customer and the CSR. It is contemplated that the entire interaction or a portion of the interaction can be recorded.

Upon receiving the data packet 235, the recording server 209 determines whether to record the audio data contained in the data packet 235 in either the first audio track 237 or the second audio track 239 of the first data file 241 as determined by the source address, destination address, and/or the audio data contained within the received data packet 235. Alternatively, two first data files can be created, wherein the first audio track is recorded to the one of the first data file and the second audio track is recorded to the second first data file. In one embodiment, if the data packet 235 comprises a source address identifying the address of the outside customer, a destination address identifying the address of the outside customer, and first constituent audio data, the first constituent audio data is recorded on the first audio track 237 of the first data file 241. Similarly, if the data packet 235 comprises a source address identifying the address of the CSR, a destination address identifying the address of the CSR, and second constituent audio data, the second constituent audio data is recorded on the second audio track 239 of the first data file 241. It should be noted that the first and second constituent audio data can be a digital or analog audio waveform or a textual translation of the digital or analog waveform. The recording process is repeated until the communication link between the outside customer and contact center CSR is terminated.

As noted above, the recording server 209 can be connected to the trunk lines of the PSTN 203 as seen in FIG. 2. The PSTN 203 can utilize a different protocol and therefore, the recording server 209 is configured to identify the communication protocol utilized by the PSTN 203, recognize the source and destination address of a signal and extract the audio data from the PSTN 203. The recording server 209 is programmed in a manner as known to one of ordinary skill in the art.

Once the communication link is terminated, the recording server 209 ends the recording session and stores the single data file having the recorded communication session in memory. After the first data file is stored in memory, the recording server 209 can extract either or both of the first constituent audio data from the first audio track of the first data file or the second constituent audio data from the second audio track of the first data file. In one embodiment, the first constituent audio data extracted from the first audio track is stored in a first constituent data file 243. Similarly, the second constituent audio data extracted from the second audio track can be stored in a second constituent data file 245. The first and second constituent data files 243, 245 can be compressed before being stored in memory. The extracted data can be in the form of a digital or analog audio waveform or can be a textual translation of the first or second constituent audio data. It is contemplated that either or both of the first constituent data file 243 or the second constituent data file 245 can be further analyzed or processed. For example, among other processes and analysis, filtering techniques can be applied to the first constituent data file and/or the second constituent data file. Moreover, event data, such as silence periods or over-talking, can be identified through analysis techniques known to those skilled in the art.

Further, as illustrated in FIG. 5, the first constituent data file 243 and the second constituent data file 245 can be merged together into a single second data file 247. The first and second constituent data files can be merged in a stereo format where the first constituent audio data from the first constituent data file 243 is stored on a first audio track of the second data file 247 and the second constituent audio data from the second constituent data file 245 is stored on a second audio track of the second data file 247. Alternatively, the first and second constituent data files can be merged in a mono format where the first constituent audio data from the first constituent data file 243 and the second constituent audio data from the second constituent data file 245 are stored on a first audio track of the second data file 247. Additionally, the first and second constituent audio data can be merged into a document having a textual translation of the audio data. In such a case, identifiers can be associated with each of the merged first and second constituent audio data in order to associate the merged first constituent audio data with the outside caller, and associate the merged second constituent audio data with the call center agent. The second data file 247 can be compressed before being stored in memory.

It is known in the art that “cradle-to-grave” recording may be used to record all information related to a particular telephone call from the time the call enters the contact center to the later of: the caller hanging up or the agent completing the transaction. All of the interactions during the call are recorded, including interaction with an IVR system, time spent on hold, data keyed through the customer's key pad, conversations with the CSR, and screens displayed by the CSR at his/her station during the transaction.

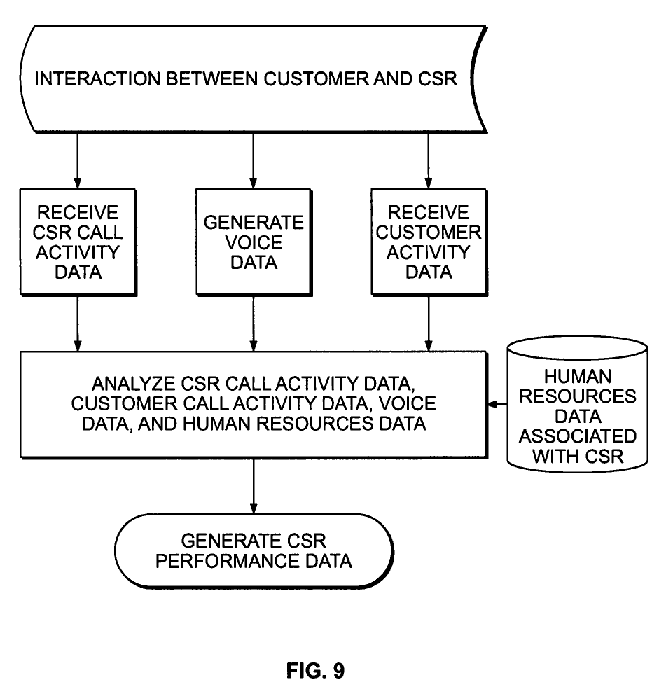

As shown in FIGS. 9-19, the present invention provides a method of aggregating various types of data associated with an interaction between a customer and a CSR. The method of aggregating data includes the step of receiving customer service representative call activity data 110 associated with the interaction. The customer service representative call activity data includes one or more of the following data types: CSR on-call activity data, CSR after-call activity data, CSR screen analytics and CSR desktop recording data. The method also includes the step of receiving customer call activity data 120. The method also includes the step of generating associated voice data from the received interaction 130. The method also includes the step of receiving human resources data from a human resources database 140. The human resources data is associated with one or more customer service representatives. The method also includes the step of analyzing the customer service representative call activity data, the customer call activity data, the voice data, and the human resources data 150. In addition, the method includes the step of generating customer service representative performance data based on the analysis of the customer service representative call activity data, the customer call activity data, the voice data and the human resources data 160.

According to one embodiment this method is implemented by a computer program. As discussed above, the computer program is preferably embodied on a computer readable storage medium adapted to control a computer and includes a plurality of instructions (e.g., code segments) for performing the task. The computer program, according to one embodiment of the invention, receives customer service representative call activity data 20 associated with an interaction. The CSR call activity data includes one or more of the following data sub-components: CSR on-call activity data, CSR after-call activity data, CSR screen analytics, and CSR desktop recording data.

In one preferred embodiment, the CSR on-call activity data can be, for example, the customer service representative's interaction with an IVR system, or data keyed through the CSR's keypad. The CSR on-call activity data can also include incremental data relating to the length of time the CSR put the customer on hold, the number of times the CSR put the customer on hold, the number of transfers associated with the call, or the entire time spent on the call. CSR on-call activity data can also be the screens displayed by the CSR on his/her station during the interaction. It will be understood by one of skill in the art, that the CSR on-call activity data 20 can be one or more of these activities or occurrences. It will also be understood that on-call activity data can include other data generated during an interaction.

After an interaction between a CSR and a customer, it is also commonly understood that a CSR may engage in activity relating to the terminated interaction. According to the present invention, data collected from after a call is terminated through the CSR's completion of the interaction is collectively CSR after-call activity. The CSR after-call activity can include, but is not limited to, notes the CSR makes about the interaction (including the time to prepare such notes), screens displayed by the CSR on his/her station after the call is terminated, time CSR spent completing the interaction, and follow-up activity with the customer.

In addition, one embodiment of the present invention contemplates receiving screen analytics and desktop recording data associated with the activity of the CSR during, and after, the interaction. The screen analytics can include, but is not limited to, capturing a CSR's mouse movements, screens displayed by the CSR at the CSR's terminal, and desktop data reviewed and entered by the CSR. It is understood that the screen analytics for a CSR may be captured by a device provided by an original equipment manufacturer (“OEM”) such as lontas or any other known providers of screen capture technology. It is further contemplated that desktop recording software produces a video recording of a CSR's desktop activity. Typically, the recording will capture, in a bitmap image or video, all or a desired portion of a CSR's desktop activity during and after the interaction. The image or video may be played back at a later time for further analysis. Examples of suitable commercially available desktop recorders include, but are not limited to, recorders offered by Nice, Funk Systems, and eTalk.

The computer program also receives customer call activity data 30. According to one embodiment of the present invention, the customer call activity data 30 can be a customer's interaction with an IVR system or other data keyed through the caller's key pad. It will be understood that customer call activity data may be generated and transmitted as discussed herein, or by another means known to those of ordinary skill.

In a preferred embodiment, an interaction between a customer and a CSR is recorded, and the voice data of the telephonic communication, is received and separated into customer voice data and CSR voice data. It will be understood that additional data may also be included in the interaction. The separated customer service representative voice data and the separated customer voice data are then mined and analyzed 40. More particularly, the voice data can be analyzed by applying one or more of the following analytical models: a linguistic based psychological behavioral model, a distress based model, and a non-linguistic event model.

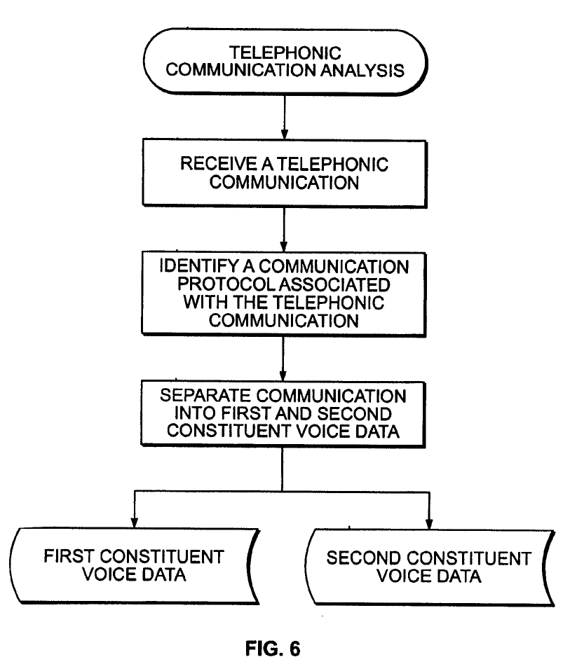

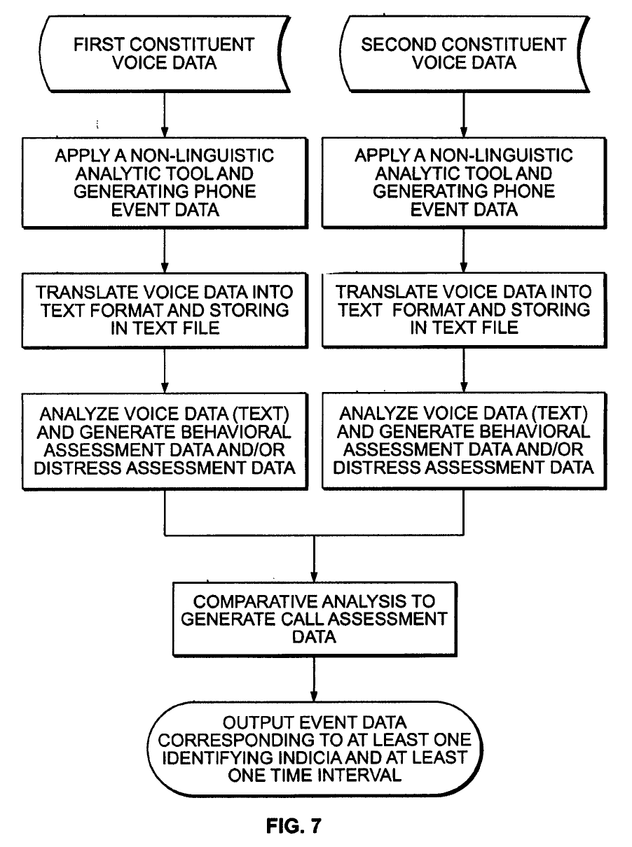

As is generally shown in FIGS. 6 and 7, once the customer and CSR voice data are separated one from the other, each of the separated customer and CSR voice data can be independently mined and analyzed. It will be understood that “mining” as referenced herein is to be considered part of the process of analyzing the separated voice data of the customer and the CSR. It is also contemplated by the present invention that the mining and behavioral analysis can be conducted on either or both of the separated voice data of the customer and the CSR.

It is contemplated by the present invention that mining and analysis in accordance with the present invention can be applied directly to the voice data configured in audio format. Preferably, however, the voice data to be mined and analyzed is first translated into a text file. It will be understood by those of skill that the translation of audio to text and subsequent data mining may be accomplished by systems known in the art. For example, the method of the present invention may employ software such as that sold under the brand name Audio Mining SDK by Scansoft, Inc., or any other audio mining software suitable for such applications.

In one embodiment of the present invention, the separated customer voice data and the separated CSR voice data are mined for behavioral signifiers associated with a linguistic-based psychological behavioral model. In particular, the separated customer voice data and the separated CSR voice data are searched for text-based keywords (i.e., behavioral signifiers) relevant to a predetermined psychological behavioral model. One preferred such psychological behavioral model and behavioral analysis is described in U.S. patent application Ser. No. 11/131,486, which is incorporated herein by reference.

The resultant behavioral signifiers 55 derived from the mining of the separated customer voice data and the separated CSR voice data may be used to evaluate qualities of a single communicant (e.g., the customer or CSR behavioral type, etc.) and to generate behavioral assessment data. For example, the behavioral assessment data can include customer reaction to a CSR based on the compatibility of a CSR's behavioral type and a customer's behavioral type, and CSR reaction to a customer based on the compatibility of a CSR's behavioral type and customer's behavioral type. The results generated by analyzing the separated CSR voice data and the separated customer voice data through application of a psychological behavioral model to the separated customer voice data and the separated CSR voice data are stored in a database for subsequent analysis of the interaction, as well as for use in generating CSR performance data.

The separated CSR voice data and separated customer voice data can also be analyzed by applying a distress based model. Preferably, a linguistic-based distress analysis is conducted on both the textual translation of the voice data and the audio file containing voice data. Accordingly, linguistic-based analytic tools as well as non-linguistic analytic tools may be applied to the audio file. For example, one of skill in the art may apply spectral analysis to the audio file voice data while applying a word spotting analytical tool to the text file. Linguistic-based word spotting analysis and algorithms for identifying distress can be applied to the textual translation of the communication. Preferably, the resultant distress data is also stored in the customer history database for subsequent analysis of the communication and to generate CSR performance data. In particular, the distress based model searches for word based distress signifiers to generate distress assessment data from the separated CSR and customer voice data. Distress assessment data can include, for example, data relating to instances in which a customer becomes upset during an interaction or dissatisfied with a CSR's response. Distress data can also include those identified instances in which a customer's issue remains unresolved.

The separated voice data of the customer and the CSR can also be analyzed by applying a non-linguistic event analysis that looks for non-linguistic phone events occurring during the course of an interaction to generate phone event assessment data. Phone event assessment data can include in whole, or in part, components of the call such as “dead air”, overtalk, cross-sells, and call type. Preferably, the phone event assessment data is generated by analyzing non-linguistic information from both the separated voice data of the customer and the CSR, or from the subsequently generated audio file containing at least some of the remerged audio data of the original audio waveform. It is also contemplated that the phone event assessment data can be generated before the audio waveform is separated. The generated phone event assessment data can also be stored in a database to use in generating CSR performance data.

According to the present invention, the computer program also receives human resources data associated with a CSR from a human resources database 50. The human resources database 50 is configured to store human resources data associated with one or more customer service representatives. For example, the human resources database 50 may include information relating to a CSR's gender, race, age, salary, education, tenure and behavioral type. It will be understood that the data included in the human resources database 50 is not limited to the information described herein, but may include any human resource information regarding a customer service representative's identity. It will also be understood that the human resources database 50 is preferably a relational database. The human resources database can be housed on a common server or a server separate from that on which the recording software is stored.

According to the present invention, a CSR's performance for an interaction 60 is analyzed by aggregating the customer service representative call activity data associated with the interaction, the customer call activity data associated with the interaction, the voice data associated with the interaction, as well as the human resources data associated with the CSR. The voice data can include: behavioral assessment data, distress assessment data, and/or phone event assessment data. Preferably, the aggregated customer service representative activity data, the customer call activity data, the voice data, and the human resources data are comparatively analyzed to provide an assessment of a CSR's performance for a given interaction and to generate CSR performance data. It is understood that in performing the comparative analysis, the voice data, the customer service representative call activity data, and the customer call activity data may be aggregated and weighted according to an algorithm suitable for a particular client's needs and values. In addition, CSR performance data may be generated by juxtaposing the results of the analysis of the voice data, the customer service representative call activity data, and the customer call activity data for a CSR interaction, with the human resources data associated with the CSR, and then further analyzing the data as will be explained later herein.

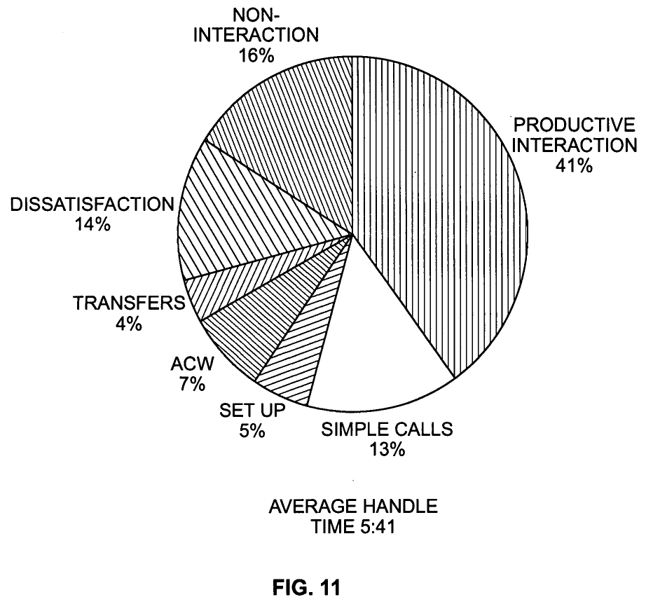

FIGS. 11-19 illustrate different embodiments of this invention for generating CSR performance data, which can be displayed through a graphical user interface (“GUI”). In one embodiment of the present invention, the customer service representative performance data is a call performance score. A call performance score is created for every CSR interaction with a customer. The score evaluates the overall effectiveness of the CSR for a customer interaction by analyzing the multiple dimensions of the CSR interaction with a customer (e.g., the customer service representative call activity data, the customer call activity data, and the voice data). The score algorithm may be tailored for a particular client's needs and values One preferred score algorithm is described in the assignee's co-pending U.S. patent application Ser. No. ______ (Attorney Docket No. 077145-023). The disclosure of that co-pending application is incorporated herein by reference.

In addition, it is contemplated that a CSR call performance score can be analyzed in combination with the CSR's human resources data to provide a more complete picture of the factors and attributes that might have impacted the CSR's performance in an interaction. For example, a low CSR performance score, viewed in context with the CSR's human resources data showing that a CSR has had a short tenure at the company, might indicate that the low score was due to the CSR's inexperience, rather than a particular performance defect during the interaction.

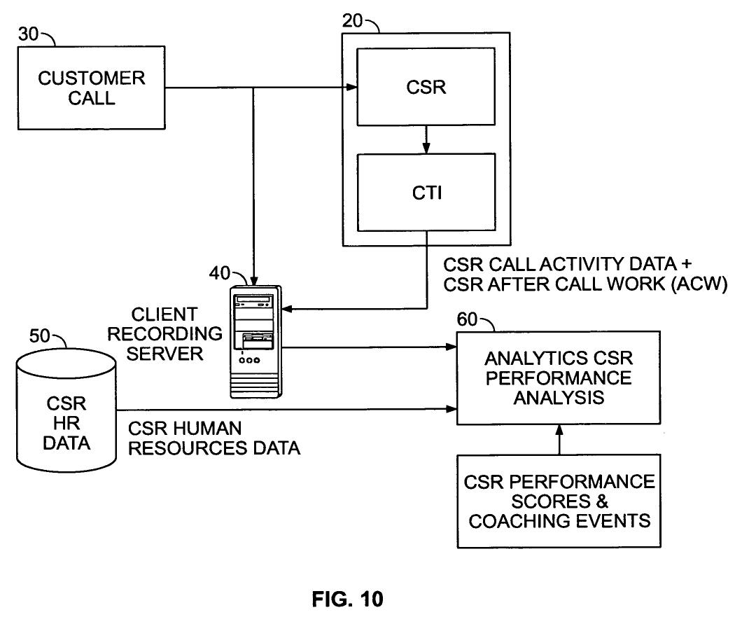

Alternatively, the customer service representative performance data can be output data evaluating a CSR's performance for a given interaction. Accordingly, output data in the form of a graphical user interface, can be generated to reflect the customer representative performance data in the format of call event assessment data, voice assessment data and after-call activity assessment data. Preferably, as discussed in detail below, the CSR performance data in the format of call event assessment data, voice assessment data and after-call activity assessment data, is comprised of a plurality of sub-categories. In addition, as shown in FIGS. 10-13, and explained further herein, it is understood that the customer service representative performance data may reflect at least one of the identified formats (i.e., call event assessment data, voice assessment data, and after-call activity assessment data) and sub-categories relative to the total interaction time between the CSR and the customer.

According to one embodiment it, is contemplated that call event assessment data evaluates a CSR's performance in relation to non-linguistic phone events occurring during the course of the interaction. A CSR's performance in relation to non-linguistic phone events occurring during the course of the interaction may be based, in whole or in part, on the CSR's phone assessment data, CSR's call activity data, or customer's call activity data associated with an interaction. Call event assessment data may include further subcategories such as excessive hold/silence times, overtalk, long duration for call types, productive use of communication time (e.g., achieve a sale, resolve customer problem, attempt a cross-sell), appropriate screens pulled up on CSR's station during the call, proper transfer of the call, or other non-linguistic phone events occurring during the course of the communication. It will be understood that these subcategories are non-exhaustive, and that call event assessment data can include any other non-linguistic phone event associated with a particular interaction.

According to the present invention, voice assessment data evaluates a CSR's performance in relation to linguistic events occurring during an interaction. A CSR's performance in relation to linguistic events can be based on either, or both of, the generated behavioral assessment data or distress assessment data associated with the interaction. According to one embodiment, the voice assessment data consists of several sub-categories. For example, the voice assessment data may include data relating to those instances when a customer became upset or dissatisfied, instances when an issue remained unresolved, or those instances in which an inappropriate response has been provided to a customer. It will be understood that these subcategories are non-exhaustive, and that voice assessment data can include any other linguistic event associated with a particular interaction.

Voice assessment data can reflect an assessment of linguistic events, or a combination of linguistic events, occurring during an interaction. For example, voice assessment data can reflect data qualifying linguistic evaluations of an upset customer, unresolved issues, or program dissatisfaction. Alternatively, or in addition, voice assessment data can only assess a specific sub-category, such as instances when a customer became distressed and measure how the CSR performed during an interaction.

After-call activity assessment data measures a CSR's performance in relation to how effectively CSR used his or her time from the time from after a call is terminated through the CSR's completion of the interaction. After-call assessment activity data can include further subcategories such as quality of notes taken after the call, duration of time spent wrapping up the interaction, and follow-up with the customer.

In one embodiment, after-call activity assessment data reflects an assessment of after-call activities performed by a CSR, or a combination of after-call activities performed by a CSR from the time from after a call is terminated through the CSR's completion of the interaction. For example, the after-call activity assessment data can qualify a CSR's productivity after a call is terminated by evaluating the quality of CSR's after-call notes, and prompt follow-up with customer. Alternatively, after-call activity assessment data may only assess a specific subcategory, in isolation, such as quality of notes to measure how the CSR performed during an interaction.

The CSR performance data and human resources data can also be analyzed. To provide a more complete picture of the factors and attributes, other than CSR's interaction with the customer, that might have impacted the CSR's performance during an interaction. For example, poor performance data, viewed in context with the CSR's human resource data showing that a CSR has had a short tenure at the company, might indicate that the poor performance data was due to CSR's inexperience, rather than a particular performance defect during the interaction.

In one embodiment of the present invent invention shown in FIGS. 11-14, aggregate CSR performance data is generated from two or more CSR interactions. As shown in FIG. 11, an aggregation of CSR performance data is generated from two or more interactions for a single CSR may be generated. For example, as shown in FIG. 11, performance data is generated by analyzing the amount of time a CSR spends on a particular subcategory of data relative to the total interaction time for the selected interaction:

$$Performance Data = \frac{Time CSR performs identified subcategory}{Total interaction time for all of CSR ' s interactions}$$

Thus, in this embodiment, the algorithm used to generate the CSR performance data is based on a ratio of time spent on a data subcategory to total interaction time.

The performance data may then be generated in graphical form (e.g., pie chart, table, etc) such that a percentage of time spent on particular subcategories of data are shown. For example, FIG. 11 illustrates the percentage of the non-interaction, dissatisfaction, transfers, after call work (acw), set up, simple calls, productive interaction relative to the total time for a given CSR's interactions.

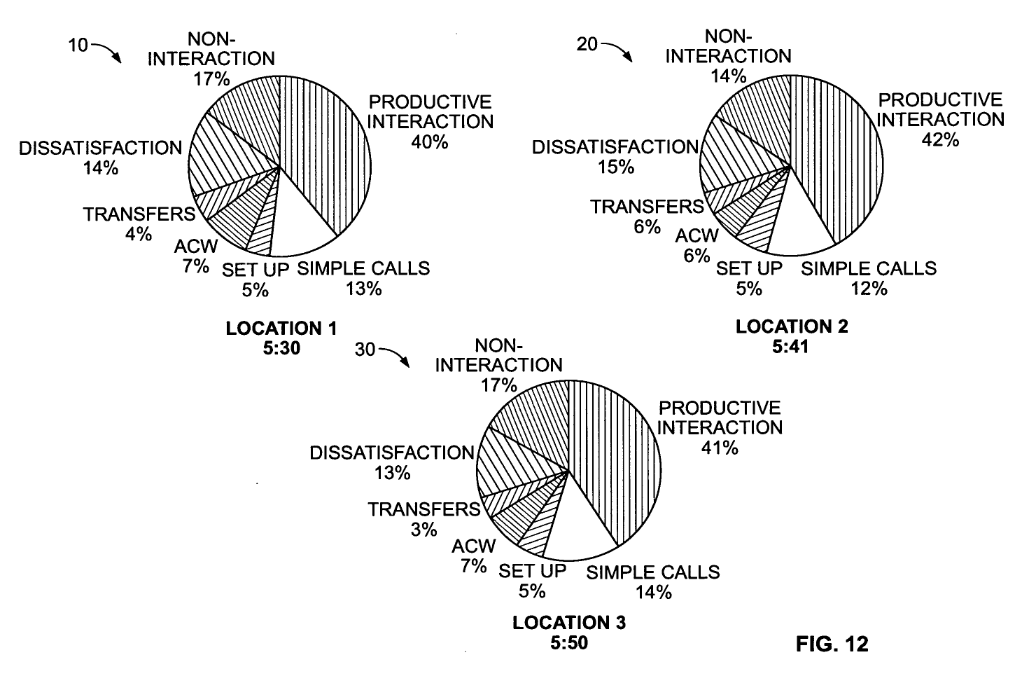

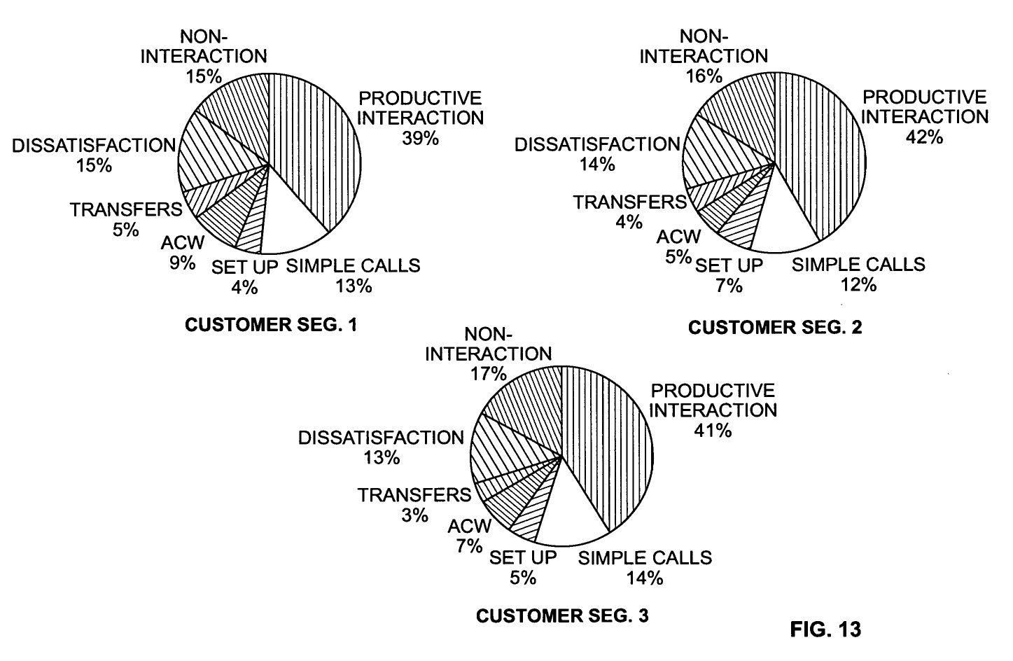

Alternatively, or in addition, the aggregate CSR performance data can be generated from the interactions of a group of two or more CSRs. For example, the program can generate aggregate CSR performance data from a plurality of interaction for each of the CSRs working in the same contact center location (FIG. 12). Similarly, aggregate CSR performance data can be generated for CRS working in the same customer segment. Indeed, it will be understood that aggregate CSR data can be generated for CRS sharing common characteristics or attributes other than common contact center or customer segment without departing from the present invention. Thus, as show in FIGS. 12-13, the aggregated CSR performance data will have a total aggregated time (i.e. the time associated with the identified performance data format) associated therewith. The total aggregate time can be comprised of a plurality of aggregated CSR performance data sub-categories, each having a constituent time component. The constituent time component of at least one of the data sub-categories relative to the total aggregate time of the communication.

FIG. 12 illustrates aggregate CSR performance data generated for all the CSRs in an identified location. Accordingly, in the embodiment, an algorithm used to generate CSR performance data is based on the ratio of time spent on a data subcategory to a total aggregate CSR interaction time:

$$Performance Data = \frac{Time CSR performs identified category activity}{Total interaction time for all of CSRs ' interactions}$$

The subcategories of performance data may then be generated in graphical form (e.g., pie chart, table, etc) such that the total aggregate CSR time is viewed in terms of percentage of time spent in each subcategory. For example, FIG. 12 illustrates the percentage of the non-interaction, dissatisfaction, transfers, after call work (acw), set up, simple calls, productive interaction relative to the total time for a group of CSRs in three separate locations 10, 20, 30.

Alternatively an algorithm may be employed to generate CSR performance data based on the average time a CSR spends on a particular subcategory of data at a particular contact center to a total aggregate time for all CSRs at that contact center:

$$Performance Data = \frac{\begin{matrix}Average time CSR performs \\ subcategory at a particular location\end{matrix}}{\begin{matrix}Average t otal interaction time for all \\ CSRs at a particular location\end{matrix}}$$

According to the present invention, the generated aggregate performance data is compared with a CSR's human resources data to analyze the impact of the demographic characteristics of the CSRs in relation to their performance. For example, by looking at a CSR's performance data in combination with associated CSR human resources data, an assessment can be made as to whether the most effective CSRs (i.e. the highest performing CSRs) are being paid the highest salaries, have the longest tenure, or are more likely to be of a particular gender, race or behavioral type. The analysis can be used by a company to engage in more targeted hiring practices, to predict future CSR behavior, or in other ways understood by one skilled in the art.

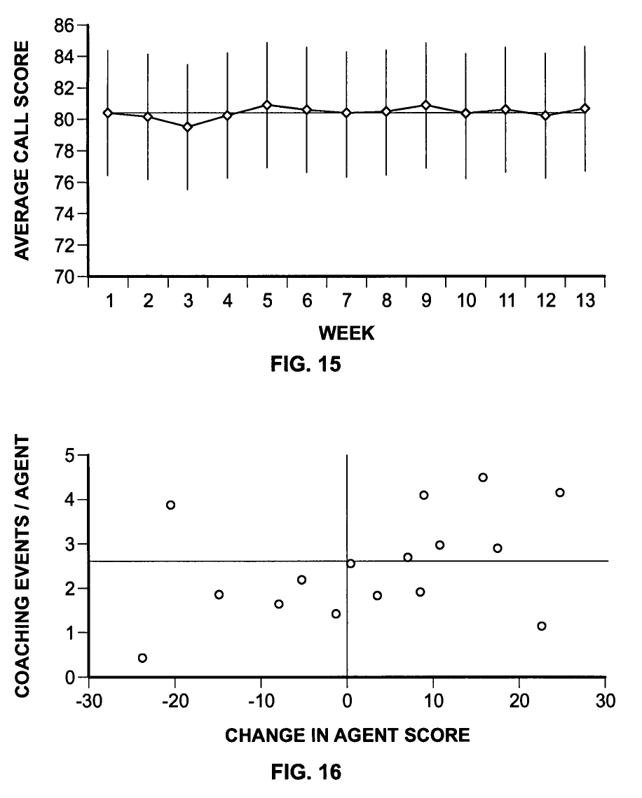

In one embodiment of the invention, as shown in FIGS. 15-17, the computer program compares the generated customer service representative performance data against existing data. For example, generated CSR data may be compared against previously generated customer service representative performance data, past coaching event data, predetermined threshold data, or peer customer service representative performance data.

According to one embodiment, CSR's generated performance data of at least one format (whether a score, call event assessment data, voice assessment data, or after-call activity assessment data), will be compared with a previously generated performance data for that CSR of that same format. Alternatively, one type of CSR's generated performance data subcategory such as hold times, transfers etc, will be compared with a previously generated performance data for that CSR of that same subcategory. The previously generated CSR performance data can be generated from one prior communication. Alternatively, the previously generated CSR performance data can be generated from a plurality of prior communications. The resulting comparison will provide an indication of whether the CSR performed at equal level, better or worse. In other words, data will be generated which is indicative of improvement, stagnation, or decline in a CSR's or group of CSR's performance.

An example of previously generated performance data for a CSR is shown in FIG. 15. Specifically, FIG. 15 illustrates a CSR's average call performance score each week over a thirteen week period. As discussed above herein, the present invention can analyze the voice data, the customer service representative call activity data, and the customer call activity data to generate a score for the customer service representative's performance in handling an interaction. It is contemplated that these CSR call performance scores can be averaged to produce an average performance score for a CSR.

In another embodiment, CSR performance data may be compared to past coaching event data. It is contemplated that coaching event data can include any training event to improve the performance of a CSR in an interaction with a customer. Typically, the coaching event will be aimed at improving a CSR performance's in relation to one or more of the following performance data formats: call event assessment data, voice assessment data, and after-call activity assessment data. These performance data formats can further include one or more of the following sub-categories: hold/silence times, overtalk, long duration for call types, productive use of communication time (e.g. achieve a sale, resolve customer problem, attempt a cross-sale), appropriate screens pulled up on CSR's station during the call, proper transfer of the call, or other non-linguistic phone events occurring during the course of the communication, upset customer, unresolved issue or program dissatisfaction, productive use of after-call time (e.g. quality of notes taken after the call, duration of time spent wrapping up the transaction). It is contemplated, that the program will identify, either or both, a format or subcategory of CSR performance data and compare the CSR performance data results with whether the CSR has received any coaching for that performance data format or sub-category. The results of the comparison can be used to determine whether the CSR has received coaching, and has improved. Conversely, the CSR has not yet received coaching, and that the CSR requires coaching for a particular performance data format or subcategory. Alternatively, the CSR performance data results indicate that a CSR does not require coaching. It is understood that a comparison between CSR performance data and coaching event data can be done for one CSR or for a group of CSRs as shown in FIG. 16.

In another embodiment of the invention, CSR performance data is compared to a predetermined threshold for particular performance data formats, or sub-categories. The threshold can be a predetermined criteria set at a contact center, by a customer, by an industry, or other objective or subjective criteria. Alternatively, the threshold can be set by one, or an average of, the prior CSR performance scores. For example, if prior generated score for hold times was 80%, the threshold is then set at 80%, and CSR's presently generated performance data will be compared against the 80% threshold. It is contemplated that at least one CSR performance data format or subcategory will beautomatically identified or manually input. The generated CSR performance data for that identifies CSR performance data format or subcategory will be compared with the predetermined threshold to evaluate the CSR. It is also contemplated that a threshold can be set by one or more characteristics of a CSR's human resources data. For example, for a CSR who earns a high salary, the CSR's performance data might be set to a higher threshold than a CSR who earns a lower salary.

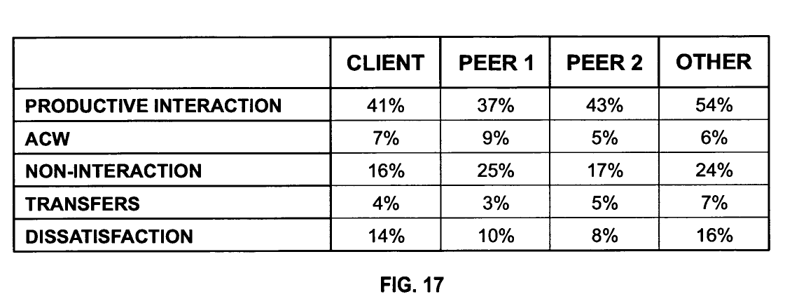

In still another embodiment of the inventions demonstrated in FIG. 17, CSR performance data can be compared to peer CSR performance data. It is contemplated that at least one CSR performance data format or subcategory will be identified and compared for the identified CSR performance data format/formats or subcategory/subcategories with a peer CSR's performance data for that identified format/formats or subcategory/subcategories. It is contemplated that peer CSR might be one CSR or an aggregate of CSRs. For example, peer CSR performance data can include a plurality of CSRs working at a location, a plurality of CSRs working for the same employer, or a plurality of CSRs sharing one or more human resources demographic characteristics. The peer comparison performance data may then be generated in graphical form (e.g., pie chart, table, etc).

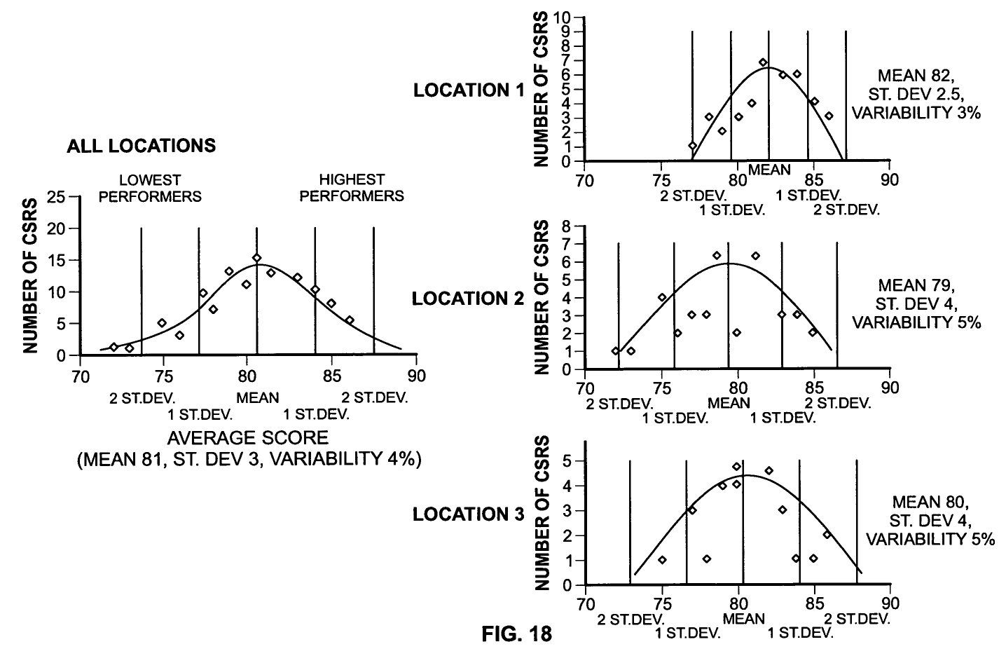

In one embodiment of the present invention-as shown in FIG. 18, a graphical representation of a group of CSRs performance score distributions can be generated. For example, a chart may be generated that plots the CSRs performance scores for each location to find the mean and/or standard deviation of CSR performance score by location. Although FIG. 18 illustrates performance score distribution by location, it will be understood by one skilled in the art that performance score distributions can be done for many other CSR aggregations including, but not limited to, a plurality of CSRs for a customer segment, a plurality of CSRs for an enterprise, a plurality of CSRs for an industry.

It is further contemplated that the generated performance data can be used in combination with a CSRs human resource data to analyze the demographic components of the CSRs in relation to their performance. For example, a distribution of CSR performance scores can be generated by location. Accordingly, the CSRs in that location whose performance scores were in the highest quartile may be selected for subsequent analysis. More particularly, the selected CSRs can be associated with the human resources data for those selected CSRs to determine whether the CSRs share common demographical characteristics.

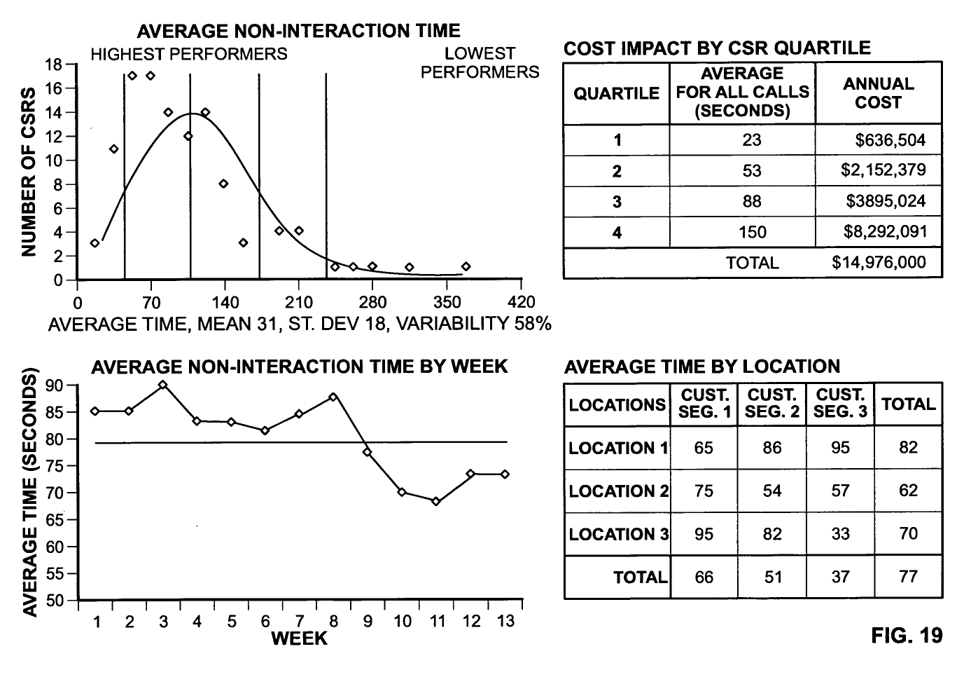

Alternatively, as shown in FIG. 19, a distribution graph 310 of CSR performance data scores for an identified subcategory (i.e. non-interaction) can be generated. Thus, as shown in FIG. 19, a graphical representation can be generated in which the average performance time for non-interaction occurring during an interaction is calculated for each quartile of CSRs. The average performance time for non-interaction can then be associated with its economic impact to the contact center. The cost impact for a given activity occurring during an interaction to a contact center, broken down by CSR quartile, may be useful to a contact center to figure out how much of its budget to allocate for coaching its CSRs on an identified activity.

While the specific embodiments have been illustrated and described, numerous modifications come to mind without significantly departing from the spirit of the invention, and the scope of protection is only limited by the scope of the accompanying Claims.

What is claimed is:

1. A computer readable medium adapted to control a computer and comprising a plurality of code segments for aggregating data associated with an interaction between a customer and a customer service representative, the computer readable medium comprising:
a code segment for receiving customer service representative call activity data associated with the interaction, the customer service representative call activity data comprising at least one of customer service representative on-call activity data, customer service representative after-call activity data, customer service representative screen analytics, and customer service representative desktop recording data;
a code segment for receiving customer call activity data;
a code segment for receiving voice data associated with an interaction;
a code segment for receiving human resources data from a human resources database, the human resources data being associated with the customer service representative;
a code segment for receiving an interaction between a customer and a customer service representative and generating associated voice data from the interaction;
a code segment for analyzing the voice data, the customer service representative call activity data, customer call activity data, and the human resources data; and,
a code segment for generating customer service representative performance data based on the analysis of the voice data, the customer service representative call activity data, the customer call activity data, and the human resources data.

2. The computer readable medium of claim 1 wherein the customer service representative call performance data comprises a customer service representative call performance score.

3. The computer readable medium of claim 1 wherein the customer service representative performance data comprises at least one of call event assessment data, voice assessment data, and after-call activity assessment data, relative to the total interaction time between the customer service representative and the customer.

4. The computer readable medium of claim 3 wherein call event assessment data, voice assessment data, and after-call activity assessment data each comprises at least a plurality of data sub-categories.

5. The computer readable medium of claim 1 further comprising:
a code segment for generating aggregate performance data from at least two of a plurality of interactions, the aggregate performance data having a total aggregate time associated therewith and comprising a plurality of aggregated data sub-categories, the aggregated data sub-categories each having a constituent time component associated therewith; and,
a code segment for analyzing the constituent time component of at least one of the plurality of data sub-categories relative to the total aggregate time for at least two of the interactions.

6. The computer readable medium of claim 1 further comprising a code segment for comparing the generated customer service representative performance data with at least one of previously generated customer service representative performance data, past coaching event data, predetermined threshold data, and peer customer service representative performance data.

7. The computer readable medium of claim 1 further comprising a code segment for generating a graphical user interface adapted to display the generated customer service representative performance data.

8. A computer readable medium adapted to control a computer and comprising a plurality of code segments for aggregating data associated with an interaction between a customer and a customer service representative, the computer readable medium comprising:
a code segment for receiving customer service representative call activity data associated with the interaction, the customer service representative call activity data comprising at least one of customer service representative on-call activity data, customer service representative after-call activity data, customer service representative screen analytics, and customer service representative desktop recording data;
a code segment for receiving customer call activity data;
a code segment for receiving voice data associated with an interaction between a customer and a customer service representative, the code segment for receiving voice data comprising:
a code segment for separating the voice data into customer voice data and customer service representative voice data;
a code segment for mining the separated customer service representative voice data and the separated customer voice data and analyzing the separated customer service representative voice data and the separated customer voice data by applying a linguistic-based psychological behavioral model to the separated customer voice data and the separated customer service representative data; and
a code segment for generating behavioral assessment data corresponding to the separated customer service representative voice data and the separated customer voice data;
a code segment for receiving the human resources data from a human resources database, the human resources data being associated with at least one customer service representative;
a code segment for analyzing the voice data, the behavioral assessment data, the customer service representative call activity data, the customer call activity data, and the human resources data; and,
a code segment for generating customer service representative performance data based on the analysis of the voice data, the behavioral assessment data, the customer service representative call activity data, the customer call activity data, and the human resources data.

9. The computer readable medium of claim 8, wherein the code segment for receiving voice data further comprises:
a code segment for analyzing the separated customer service representative voice data and the separated customer voice data by applying a distress based model to the separated customer service representative voice data and the customer voice data; and
a code segment for generating distress assessment data corresponding to the separated customer service representative voice data and the customer voice data.

10. The computer readable medium of claim 8, wherein the code segment for receiving voice data further comprises:
a code segment for analyzing the received voice data by applying a non-linguistic event analysis thereto; and
a code segment for generating phone event assessment data corresponding to the received voice data.

11. The computer readable medium of claim 8, wherein the code segment for separating the received voice data into customer voice data and customer service representative voice data comprises:
a code segment for identifying a communication protocol associated with the received voice data; and
a code segment for recording the received voice data to a first electronic data file comprising a first and second audio track, the customer service representative voice data being automatically recorded on the first audio track based on the identified communication protocol, and the customer voice data being automatically recorded on the second audio track based on the identified communication protocol.

11. The computer readable medium of claim 8 wherein the customer service representative performance data comprises a customer service representative call performance score.

12. The computer readable medium of claim 8 further comprising:
a code segment for generating aggregate performance data from at least two of the plurality of interactions, the aggregate performance data having a total aggregate time associated therewith and comprising a plurality of aggregated data sub-categories, the aggregated data sub-categories each having a constituent time component associated therewith; and,
a code segment for analyzing the constituent time component of at least one of the plurality of data sub-categories relative to the total aggregate time for at least two of the interactions.

13. The computer readable medium of claim 8 further comprising a code segment for comparing the generated customer service representative performance data with at least one of previously generated customer service representative performance data, past coaching event data, predetermined threshold data, and peer customer service representative performance data.

14. The computer readable medium of claim 8 further comprising a code segment for generating a graphical user interface adapted to display the generated customer service representative performance data.

17. A system for aggregating data associated with an interaction between a customer and a customer service representative, the system comprising:
a customer service representative performance database configured to store a plurality of customer service representative performance data;
a first server comprising:
logic for receiving voice data associated with the interaction, the logic for receiving voice data comprising:
logic for separating the voice data into at least customer voice data and customer service representative voice data;
logic for mining the separated customer service representative voice data and the separated customer voice data;
logic for analyzing the separated customer service representative voice data and customer voice data by applying a linguistic-based psychological behavioral model, a distress based model, and a non-linguistic event analysis to each of the separated customer voice data and the separated customer service representative voice data; and
logic for generating behavioral assessment data, distress assessment data, and phone event assessment data from the analyzed separated customer service representative voice data and the separated customer voice data;
logic for receiving customer service representative call activity data associated with an interaction, the customer service representative data comprising at least one of customer service representative on-call activity data, customer service representative after-call activity data, customer service representative screen analytics, and customer service representative desktop recording data;
logic for receiving customer call activity data associated with the interaction;
logic for receiving human resources data from a human resources database, the human resources data being associated with the customer service representative;
logic for analyzing the behavioral assessment data, the distress assessment data, the phone event assessment data, the customer service representative call activity data, the customer call activity data, and the human resources data;
logic for generating customer service representative performance data based on the analysis of the behavioral assessment data, the distress assessment data, the phone event assessment data, the customer service representative call activity data, the customer call activity data, and the human resources data; and
logic for communicating with a customer service representative performance data database.

16. The system of claim 15 wherein customer service representative performance data comprises a customer service representative call performance score.

17. The system of claim 15 wherein customer service representative performance data comprises at least one of call event assessment data, voice assessment data, and after-call activity assessment data and each of their constituent time components, relative to the total interaction time between the customer service representative and the customer.

18. The system of claim 17 wherein call event assessment data, voice assessment data, and after-call activity assessment data each comprises at least a plurality of data sub-categories.

19. The system of claim 15 further comprising logic for comparing the generated customer service representative performance data with at least one of previously generated customer service representative performance data, past coaching event data, predetermined threshold data, and peer customer service representative performance data.

20. The system of claim 15 further comprising:
a coaching event database configured to store at least one prior coaching event; and
a human resources database configured to store in association with at least one customer service representative least one of tenure, gender, race, age, salary, education, and personality type data.
